(19) United States
(12) Patent Application Publication
(10) Pub. No.: US 2009/0281216 A1
(43) Pub. Date: Nov. 12, 2009

(54) IMPACT-MODIFIED POLYCARBONATE COMPOSITIONS WITH HIGH HYDROLYSIS RESISTANCE AND A LIGHT NATURAL COLOUR

(75) Inventors: Evgueni AVTOMONOV, Leverkusen (DE); Andreas SEIDEL, Dormagen (DE); Thomas ECKEL, Dormagen (DE); Eckhard WENZ, Koln (DE)

Correspondence Address: Baker Donelson Bearman, Caldwell & Berkowitz, PC, 555 Eleventh Street, NW, Sixth Floor, Washington, DC, 20004, US

(73) Assignee: BAYER MATERIALSCIENCE AG, Leverkusen (DE)

(21) Appl. No.: 12/428,256

(22) Filed: Apr. 22, 2009

(30) Foreign Application Priority Data
Apr. 24, 2008 (DE) 102008020437.4

(51) Int. Cl. C08K 5/3492; C08K 5/13; C08K 5/52; C08K 5/10; C08K 5/53; C08K 5/36

(52) U.S. Cl. 524/101; 524/323; 524/127; 524/343; 524/287; 524/349; 524/147; 524/133; 524/303

(57) ABSTRACT

The present invention relates to polycarbonate compositions comprising: A) an aromatic polycarbonate and/or aromatic polyester carbonate; B) a graft polymer obtainable by co-precipitation of a mixture of at least two graft polymer dispersions B.1 and B.2, wherein the production of the graft polymer component B.1 takes place using at least one redox system as initiator and wherein the production of the graft polymer component B.2 takes place using at least one persulfate compound as initiator; C) optionally a vinyl (co)polymer and/or polyalkylene terephthalate; D) optionally a phosphorus-containing flame retardant; E) at least one phenolic antioxidant; F) optionally a neutral phosphorus- or sulfur-containing co-stabilisers (synergists); and G) optionally additives. Compositions of the present invention are distinguished by an optimum combination of good hydrolysis resistance and a light natural colour. The present invention also relates to the use of polycarbonate compositions for the production of mouldings and mouldings per se as well.

### CROSS REFERENCE TO RELATED APPLICATION

This application claims priority to German Patent Application No. 102008020437.4, filed Apr. 24, 2008, the intent of which is incorporated herein by reference in its entirety.

### BACKGROUND OF THE INVENTION

1. Field of the Invention

The present invention relates to thermoplastic polycarbonate compositions (moulding compositions) impact-modified with a specially produced and worked up graft polymer, a process for the production thereof and moulded parts produced therefrom.

2. Description of Related Art

Thermoplastic moulding compositions comprising polycarbonates and ABS polymers have long been known. DE-A 1 170 141, for example, describes readily processable moulding compositions comprising polycarbonates and graft polymers of monomer mixtures of acrylonitrile and an aromatic vinyl hydrocarbon on polybutadiene.

In DE-A 1 810 993, the improved heat resistance of polycarbonate in admixture with ABS graft polymers or copolymers based on α-methylstyrene is emphasised.

The subject-matter of DE-A 22 59 565 and DE-A 23 29 548 is the improved flow line strength of PC/ABS moulding compositions, graft polymers of a particular particle size being used in both specifications as a constituent of the ABS component. EP-A 0 704 488 discloses thermoplastic moulding compositions having a particle diameter of 0.20 to 0.35 μm.

DE-A 28 18 679 teaches that PC/ABS mixtures exhibit particularly high low-temperature strength when the ABS polymer contains two graft copolymers having different degrees of grafting.

In addition, depending on the purity and additive content of the impact modifier, e.g. ABS (acrylonitrile-butadiene-styrene terpolymer), polycarbonate compositions containing graft polymers as impact modifiers can have different stability towards hydrolysis and thermal load. Thus, B. S. Patty, L. Novak and H. Phan (in “Thermal and hydrolytic stability of polycarbonate/acrylonitrile-butadiene-styrene based blends”, Society of Automotive Engineers, [Special Publication] SP (2005), SP-1960 (Advances in Plastic Components, Processes and Technologies), 145-151) describe polycarbonate compositions which exhibit significantly better hydrolytic stability and thermal stability with bulk ABS as modifier than in the case of emulsion ABS as modifier. The different behaviour of the polycarbonate/bulk ABS compositions compared with polycarbonate/emulsion ABS compositions is attributed here to the fact that the production process for emulsion ABS requires a greater number of different chemicals as auxiliary substances, such as e.g. emulsifiers, flow improvers, stabilisers, salts etc., compared with bulk ABS, these chemicals also including ones that can lead to the decomposition of the polycarbonate. Another advantage of the polycarbonate/bulk ABS compositions is a particularly light inherent colour (natural colour), which has a particularly advantageous effect on the colouring of the mouldings consisting of these compositions.

Certain polycarbonate compositions containing emulsion graft polymers as impact modifier have some technical advantages compared with polycarbonate compositions containing bulk ABS, e.g. in terms of the surface finish (gloss), so that it is advantageous for some applications to use emulsion graft polymers. If high hydrolytic stability is required, high demands must be placed on the emulsion graft polymers used, such as e.g. in terms of their purity, the work-up process in the production thereof and a lack of certain auxiliary substances in the production thereof.

From EP-A 0 900 827, for example, impact-modified polycarbonate compositions with improved thermal stability containing emulsion graft polymers are known, which are substantially free from components that degrade polycarbonate. In order to obtain an emulsion graft polymer substantially free from components that degrade polycarbonate, such components must be omitted entirely in every process step of the emulsion process or the emulsion graft polymers produced must be completely freed of these components by means of an appropriate work-up process, e.g. by washing after coagulation of the graft emulsion. In particular, the use of carboxylate-containing auxiliary substances (e.g. emulsifiers, buffer solutions) must be avoided, since these degrade polycarbonate. The polycarbonate compositions known from EP-A 0 900 827 contain emulsion graft polymers of the MBS and ABS type, which have been produced using sulfate- and/or sulfonate-containing emulsifiers. These emulsifiers often lead to undesirable discolorations of the moulding compositions.

From WO-A 99/01489, emulsion graft polymers of the ABS type are known, which are produced using a wide variety of emulsifiers. Common carboxylate-containing emulsifiers are mentioned inter alia as possible emulsifiers for the production thereof. This patent specification also teaches how particularly light-coloured ABS moulding compositions can be produced in which the processing and the acrylonitrile content in the graft polymer and in the matrix component (SAN resin) play a particularly important role. From WO-A 99/01489 it emerges above all that the compositions containing emulsion ABS have a particular tendency towards yellowing or even browning. This yellowing or browning is distinguished by a yellowness index from more than 30 to well above 50. The yellowness index here depends on several factors, including the rubber and acrylonitrile content of the ABS, the additives in the emulsion polymerisation and during the work-up and possibly on the purification of the graft polymer and the processing conditions of the moulding compositions and conditions during the production of the mouldings. Yellowing or brown discolouration is favoured by the high temperatures that occur e.g. during processing by injection moulding or while mixing with additives during compounding in an extruder.

WO-A 2004/050765 teaches about the provision of impact-modified compositions with an optimised property combination of good surface quality (particularly a very low number of defects, so-called “fish eyes”), good flow behaviour and good stress cracking resistance (ESC behaviour). To achieve this object, co-precipitated graft polymers produced by the emulsion polymerisation process were used, in which at least one graft polymer, produced by means of a redox initiation, were mixed with at least one other graft polymer, produced by means of an inorganic persulfate initiator, at the latex stage (i.e. as a polymer dispersion), and then co-precipitated and melt-compounded with the thermoplastics or a mixture of thermoplastics, including polycarbonates, polyester carbonates, polyamides and polyoxymethylene. An improvement in hydrolytic stability and in inherent colour (natural colour) of the compositions produced, particularly those compositions that contain polycarbonate, polyester carbonate and polyester, is not imparted by the teaching of WO-A 2004/050765.

### SUMMARY OF THE INVENTION

An object of the present invention was to provide impact-modified polycarbonate compositions that are distinguished by an optimum combination of good hydrolysis resistance and a light natural colour. In particular, it was an object of the present invention to provide impact-modified polycarbonate compositions which are distinguished by an optimum combination of good hydrolysis resistance and a light natural colour while maintaining good flame retardant properties, by example evaluation of V-0 for wall thicknesses of 1.5 mm.

Surprisingly, it has now been found that compositions or moulding compositions comprising:
A) an aromatic polycarbonate and/or aromatic polyester carbonate,
B) a graft polymer obtainable by co-precipitation of a mixture of at least two graft polymer dispersions, wherein production of a first graft polymer component B.1 takes place using at least one redox system as initiator and production of a second graft polymer component B.2 takes place using at least one persulfate compound as initiator,
C) optionally a vinyl (co)polymer and/or a polyalkylene terephthalate,
D) optionally a phosphorus-containing flame retardant,
E) at least one phenolic antioxidant,
F) optionally a neutral phosphorus- or sulfur-containing co-stabiliser (synergist) and
G) optionally one or more additives are capable of achieving one or more objects according to the invention.

Additional objects, features and advantages of the invention will be set forth in the description which follows, and in part, will be obvious from the description, or may be learned by practice of the invention. Objects, features and advantages of the invention may be realized and obtained by means of the instrumentalities and combination particularly pointed out in the appended claims.

### DETAILED DESCRIPTION OF A PREFERRED EMBODIMENT

Compounds are preferred which comprise:

A) 10 to 99 parts by weight, preferably 40 to 95 parts by weight, particularly preferably 50 to 85 parts by weight, aromatic polycarbonate and/or aromatic polyester carbonate,

B) 1 to 50 parts by weight, preferably 4 to 30 parts by weight, particularly preferably 12 to 25 parts by weight of a graft polymer obtainable by co-precipitation of a mixture of at least two graft polymer dispersions B.1 and B.2, characterised in that the production of the graft polymer component B.1 takes place using at least one redox system as initiator and that the production of the graft polymer component B.2 takes place using at least one persulfate compound as initiator,

C) 0 to 40 parts by weight, preferably 1 to 30 parts by weight, particularly preferably 3 to 25 parts by weight, vinyl (co)polymer and/or polyalkylene terephthalate,

D) 0 to 50 parts by weight, preferably 2 to 30 parts by weight, particularly preferably 10 to 20 parts by weight, based in each case on the sum of the parts by weight of components A+B+C, phosphorus-containing flame retardant,

E) 0.005 to 1 parts by weight, preferably 0.01 to 0.5 parts by weight, particularly preferably 0.02 to 0.3 parts by weight, based in each case on the sum of the parts by weight of components A+B+C, of at least one phenolic antioxidant,

F) 0 to 4 parts by weight, preferably 0.01 to 2 parts by weight, particularly preferably 0.05 to 0.5 parts by weight, based in each case on the sum of the parts by weight of components A+B+C, neutral phosphorus- or sulfur-containing co-stabilisers (also referred to below as synergists), and

G) 0 to 50 parts by weight, preferably 0.5 to 25 parts by weight, based in each case on the sum of components A+B+C, additives, all data relating to parts by weight in the present application being standardised such that the sum of the parts by weight of all components A+B+C in the composition add up to 100.

These constituents and other components that can be used in the compositions according to the invention are explained below by way of example.

### Component A

Aromatic polycarbonates and/or aromatic polyester carbonates according to component A which are suitable according to the invention are known from the literature and/or can be produced, for example, by processes known from the literature (for the production of aromatic polycarbonates cf. e.g. Schnell, “Chemistry and Physics of Polycarbonates”, Interscience Publishers, 1964, as well as DE-AS 1 495 626, DE-A 2 232 877, DE-A 2 703 376, DE-A 2 714 544, DE-A 3 000 610, DE-A 3 832 396; for the production of aromatic polyester carbonates e.g. DE-A 3 077 934).

The production of aromatic polycarbonates can take place e.g. by reacting diphenols with carbonic acid halides, preferably phosgene, and/or with aromatic dicarboxylic acid dihalides, preferably benzene dicarboxylic acid dihalides, by the interfacial polycondensation process with the optional use of chain terminators, e.g. monophenols, and with the optional use of trifunctional or more than trifunctional branching agents, e.g. triphenols or tetraphenols. It is likewise possible to produce them by means of a melt polymerisation process by reacting diphenols with, for example, diphenyl carbonate.

Diphenols for the production of the aromatic polycarbonates and/or aromatic polyester carbonates are preferably those of formula (I)

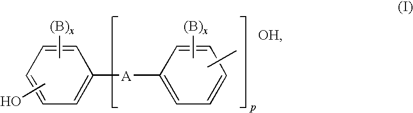

wherein

A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, on which other aromatic rings optionally containing hetero atoms can be condensed, or a group of the formulae (II) or (III)

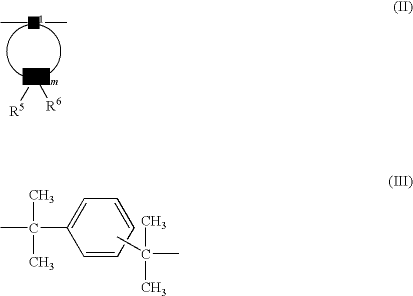

B is in each case C₁ to C₁₂ alkyl, preferably methyl, halogen, preferably chlorine and/or bromine

x is in each case independently of one another 0, 1 or 2,

p is 1 or 0, and

R⁵ and R⁶ can be selected individually for each X¹ and are, independently of one another, hydrogen or C₁ to C₆ alkyl, preferably hydrogen, methyl or ethyl,

X¹ is carbon and

m is an integer from 4 to 7, preferably 4 or 5, with the proviso that R⁵ and R⁶ are simultaneously alkyl on at least one atom X¹.

Preferred diphenols include hydroquinone, resorcinol, dihydroxydiphenols, bis(hydroxyphenyl)-C₁-C₅-alkanes, bis(hydroxyphenyl))-C₅-C₆-cycloalkanes, bis(hydroxy-phenyl)ethers, bis(hydroxyphenyl) sulfoxides, bis(hydroxyphenyl) ketones, bis(hydroxyphenyl) sulfones and α,α-bis(hydroxyphenyl) diisopropylbenzenes as well as the ring-brominated and/or ring-chlorinated derivatives thereof.

Particularly preferred diphenols include 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxdiphenyl sulfide, 4,4′-dihydroxydiphenyl sulfone and the di- and tetrabrominated or chlorinated derivatives thereof, such as e.g. 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is particularly preferred.

The diphenols can be used individually and/or as any mixtures. The diphenols are known from the literature and/or are obtainable by processes known from the literature.

Suitable chain terminators for the production of the thermoplastic, aromatic polycarbonates include, for example, phenol, p-chlorophenol, p-tert.-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 or monoalkylphenol or dialkylphenols with a total of 8 to 20 carbon atoms in the alkyl substituents, such as 3,5-di-tert.-butylphenol, p-isooctylphenol, p-tert.-octylphenol, p-dodecylphenol and 2-(3,5-dimethylheptyl)phenol and 4-(3,5-dimethylheptyl)phenol. The quantity of chain terminators to be used is generally between 0.5 mole % and 10 mole %, based on the total moles of the diphenols used in each case.

The thermoplastic aromatic polycarbonates typically have mean weight-average molecular weights (M_{w}, measured e.g. by GPC, ultracentrifuge or scattered light measurement) of 10,000 to 200,000 g/mole, preferably 15,000 to 80,000 g/mole, particularly preferably 24,000 to 32,000 g/mole.

The thermoplastic, aromatic polycarbonates can be branched in a known manner, preferably by incorporating 0.05 to 2.0 mole %, based on the sum of the diphenols used, of trifunctional or more than trifunctional compounds, e.g. those with three or more phenolic groups.

Both homopolycarbonates and copolycarbonates are suitable. For the production of copolycarbonates according to component A according to the present invention, it is also possible to use 1 to 25 wt. %, preferably 2.5 to 25 wt. %, based on the total amount of diphenols to be used, of polydiorganosiloxanes with hydroxyaryloxy end groups. These are known (U.S. Pat. No. 3,419,634) and can be produced, for example, by processes known from the literature. The production of copolycarbonates containing polydiorganosiloxanes is described, for example, in DE-A 3 334 782.

Preferred polycarbonates include, in addition to the bisphenol A homopolycarbonates, copolycarbonates of bisphenol A with up to 15 mole %, based on the total moles of diphenols, of other diphenols mentioned as preferred or particularly preferred, especially 2,2-bis(3,5-dibromo-4-hydroxyphenyl)propane.

Aromatic dicarboxylic acid dihalides for the production of aromatic polyester carbonates are preferably the diacid dichlorides of isophthalic acid, terephthalic acid, diphenyl ether 4,4′-dicarboxylic acid and of 2,6-naphthalenedicarboxylic acid.

Particularly preferred are mixtures of the diacid dichlorides of isophthalic acid and terephthalic acid in a ratio of between 1:20 and 20:1. In the production of polyester carbonates, a carbonic acid halide, preferably phosgene, can also be used as a bifunctional acid derivative.

Suitable chain terminators for the production of the aromatic polyester carbonates include, in addition to the monophenols already mentioned, their chlorocarbonic esters and the acid chlorides of aromatic monocarboxylic acids, which may optionally be substituted by C₁ to C₂₂ alkyl groups or by halogen atoms, as well as aliphatic C₂ to C₂₂ monocarboxylic acid chlorides.

The quantity of chain terminators is generally 0.1 to 10 mole % each, based in the case of the phenolic chain terminators on moles of diphenol and in the case of monocarboxylic acid chloride chain terminators on moles of dicarboxylic acid dichloride.

The aromatic polyester carbonates can also contain, if desired, incorporated aromatic hydroxycarboxylic acids.

The aromatic polyester carbonates can be both linear and branched in any known manner (cf. DE-A 2 940 024 and DE-A 3 007 934).

As branching agent, it is possible to use e.g. trifunctional or polyfunctional acyl chlorides, such as trimesic acid trichloride, cyanuric acid trichloride, 3,3′-,4,4′-benzophenone tetracarboxylic acid tetrachloride, 1,4,5,8-naphthalenetetracarboxylic acid tetrachloride or pyromellitic acid tetrachloride, in quantities of 0.01 to 1.0 mole % (based on dicarboxylic acid dichlorides used) or trifunctional or polyfunctional phenols, such as phloroglucinol, 4,6-dimethyl-2,4,6-tri-(4-hydroxyphenyl)hept-2-ene, 4,6-dimethyl-2,4,6-tri-(4-hydroxyphenyl)heptane, 1,3,5-tri-(4-hydroxyphenyl)benzene, 1,1,1-tri-(4-hydroxyphenyl)ethane, tri-(4-hydroxyphenyl)phenylmethane, 2,2-bis[4,4-bis(4-hydroxyphenyl)cyclohexyl]propane, 2,4-bis(4-hydroxyphenylisopropyl)phenol, tetra-(4-hydroxyphenyl)methane, 2,6-bis(2-hydroxy-5-methylbenzyl)-4-methylphenol, 2-(4-hydroxphenyl)-2-(2,4-dihydroxyphenyl)propane, tetra-(4-[4-hydroxyphenylisopropyl]phenoxy)methane, 1,4-bis[4,4′-dihydroxytriphenyl)methyl]benzene, in quantities, for example, of 0.01 to 1.0 mole %, based on diphenols used. Phenolic branching agents can be initially charged with the diphenols, and acid chloride branching agents can be added together with the acid dichlorides if desired.

In the thermoplastic aromatic polyester carbonates, the proportion of carbonate structural units can vary at will. The proportion of carbonate groups is preferably up to 100 mole %, particularly up to 80 mole %, more preferably up to 50 mole %, based on the sum of ester groups and carbonate groups. Both the ester and the carbonate proportion of the aromatic polyester carbonates can be present in the form of blocks and/or randomly distributed in the polycondensate.

The relative solution viscosity (ηᵣₑₗ) of the aromatic polycarbonates and polyester carbonates can be in the range of 1.18 to 1.4, preferably 1.20 to 1.32 (measured in solutions of 0.5 g polycarbonate or polyester carbonate in 100 ml methylene chloride solution at 25° C.).

The thermoplastic, aromatic polycarbonates and polyester carbonates can be used individually or in any mixture.

### Component B

Component B is a graft polymer obtainable by co-precipitation of a mixture of at least two graft polymer dispersions B.1 and B.2, wherein B.1 and B.2 are each a polymer dispersion in water of
i) 15 to 60 wt. %, preferably 25 to 60 wt. %, particularly preferably 30 to 50 wt. %, of at least one vinyl monomer on
ii) 85 to 40 wt. %, preferably 75 to 40 wt. %, particularly preferably 70 to 50 wt. %, of one or more backbones with glass transition temperatures of <10° C., preferably <0° C., particularly preferably <−20° C.

The backbone of the graft polymer obtainable by co-precipitation generally has an average particle size (d₅₀ value) of 0.05 to 5 μm, preferably 0.1 to 0.5 μm, particularly preferably 0.2 to 0.4 μm.

The monomers i) are preferably a mixture of
i1) 50 to 99 parts by weight vinyl aromatics and/or ring-substituted vinyl aromatics (such as e.g. styrene, α-methylstyrene, p-methylstyrene, p-chlorostyrene) and/or (meth)acrylic acid (C₁-C₈) alkyl esters (such as e.g. methyl methacrylate, ethyl methacrylate) and
i2) 1 to 50 parts by weight vinyl cyanides (unsaturated nitriles such as acrylonitrile and methacrylonitrile) and/or (meth)acrylic acid (C₁-C₈) alkyl esters (such as e.g. methyl methacrylate, n-butyl acrylate, t-butyl acrylate) and/or derivatives (such as anhydrides and imides) of unsaturated carboxylic acids (e.g. maleic anhydride and N-phenylmaleimide).

Preferred monomers i1) are selected from at least one of the monomers styrene, α-methylstyrene and methyl methacrylate, and preferred monomers i2) are selected from at least one of the monomers acrylonitrile, maleic anhydride and methyl methacrylate.

Particularly preferred monomers are i1) styrene and i2) acrylonitrile.

Suitable backbones ii) for the graft polymers B.1 and B.2 are e.g. diene rubbers, EP(D)M rubbers, i.e. those based on ethylene/propylene and optionally diene monomers, and also acrylate, polyurethane, silicone, chloroprene and ethylene/vinyl acetate rubbers.

Preferred backbones ii) are diene rubbers. The term diene rubbers within the meaning of the present invention is understood as diene rubbers (e.g. based on butadiene, isoprene etc.) or mixtures of diene rubbers or copolymers of diene rubbers or mixtures thereof with other copolymerisable monomers (e.g. according to i1) and i2)), preferably butadiene-styrene copolymers with preferably up to 30 wt. % styrene, with the proviso that the glass transition temperature of the component ii) is <10° C., preferably <0° C., particularly preferably <−20° C.

Pure polybutadiene rubber is particularly preferred.

Suitable acrylate rubbers according to ii) of the polymers B.1 and B.2 are preferably polymers of alkyl acrylates, optionally with up to 40 wt. %, based on ii), of other polymerisable, ethylenically unsaturated monomers. The preferred polymerisable acrylates include C₁-C₈ alkyl esters, e.g. methyl, ethyl, butyl, n-octyl and 2-ethylhexyl esters; haloalkyl esters, preferably halo-C₁-C₈-alkyl esters, such as chloroethyl acrylate, and mixtures of these monomers.

For crosslinking, monomers with more than one polymerisable double bond can be copolymerised. Preferred examples of crosslinking monomers include esters of unsaturated monocarboxylic acids with 3 to 8 C atoms and unsaturated monohydric alcohols with 3 to 12 C atoms, or saturated polyols with 2 to 4 OH groups and 2 to 20 C atoms, such as e.g. ethylene glycol dimethacrylate, allyl methacrylate; polyunsaturated heterocyclic compounds, such as e.g. trivinyl and triallyl cyanurate; polyfunctional vinyl compounds, such as di- and trivinylbenzenes; but also triallyl phosphate and diallyl phthalate.

Preferred crosslinking monomers include allyl methacrylate, ethylene glycol dimethacrylate, diallyl phthalate and heterocyclic compounds which contain at least 3 ethylenically unsaturated groups.

Particularly preferred crosslinking monomers include the cyclic monomers triallyl cyanurate, triallyl isocyanurate, triacryloylhexahydro-s-triazine, triallyl benzenes. The quantity of crosslinking monomers is preferably 0.02 to 5, particularly 0.05 to 2 wt. %, based on the backbone ii).

With cyclic crosslinking monomers having at least three ethylenically unsaturated groups, it can be advantageous to limit the quantity to less than about 1 wt. % of the backbone ii) in some cases.

Preferred “other” polymerisable, ethylenically unsaturated monomers, which may also optionally be used in addition to the acrylates for the production of the backbone ii), are e.g. acrylonitrile, styrene, α-methylstyrene, acrylamides, vinyl-C₁-C₆-alkyl ethers, methyl methacrylate and butadiene. Preferred acrylate rubbers as backbone ii) are emulsion polymers having a gel content of at least 60 wt. %.

Other suitable backbones according to ii) include silicone rubbers such as those with graft-active points as described in DE-OS 3 704 657, DE-OS 3 704 655, DE-OS 3 631 540 and DE-OS 3 631 539.

The gel content of the backbone ii) is determined at 25° C. in a suitable solvent (e.g. toluene) (M. Hoffmann, H. Kromer R. Kuhn, Polymeranalytik I and II, Georg Thieme-Verlag, Stuttgart 1977).

The mean weight-average particle size d50 is the diameter above and below which 50 wt. % of the particles lie. It can be determined by ultracentrifuge measurement (W. Scholtan, H. Lange, Kolloid-Z. und Z. Polymere 250 (1972), 782-796).

Particularly preferred polymers B.1 and B.2 include e.g. ABS polymers (preferably produced by emulsion polymerisation) as described e.g. in DE-A 2 035 390 (=U.S. Pat. No. 3,644,574) or in DE-A 2 248 242 (=GB-PS 1 409 275) or in Ullmann, Enzyklopadie der Technischen Chemie, vol. 19 (1980), pp. 280 ff. The gel content of the backbone ii) is generally at least about 30 wt. %, preferably at least 40 wt. % (measured in toluene).

Graft polymers with a core-shell structure are preferred in some cases.

The graft copolymers B.1 and B.2 are generally produced by free-radical polymerisation and preferably by emulsion polymerisation.

The graft polymer B.1 to be used according to the present invention is produced by redox initiation.

Redox initiator systems that are suitable according to the invention generally comprise or consist of an organic oxidising agent and a reducing agent, with the possible additional presence of heavy metal ions in the reaction medium; it can be preferable to work without heavy metal ions.

Organic oxidising agents that are suitable according to the invention are, for example and preferably, di-tert.-butyl peroxide, cumene hydroperoxide, dicyclohexyl percarbonate, tert.-butyl hydroperoxide, p-menthane hydroperoxide or mixtures thereof, cumene hydroperoxide and tert.-butyl hydroperoxide are particularly preferred. Instead of the organic oxidising agent, it is also possible to use H₂O₂ as oxidising agent in the redox initiator system.

Reducing agents that can be used according to the present invention include preferably water-soluble compounds with a reducing action, preferably selected from the group of the salts of sulfinic acid, salts of sulfurous acid, sodium dithionite, sodium sulfite, sodium hyposulfite, sodium hydrogen sulfite, ascorbic acid and its salts, Rongalit® C (sodium formaldehyde sulfoxylate), mono- and dihydroxyacetone, sugars (e.g. glucose or dextrose). In principle, it is also possible to use e.g. iron(II) salts, such as e.g. iron(II) sulfate, tin(II) salts, such as e.g. tin(II) chloride, titanium(III) salts, such as titanium(III) sulfate; preferably, however, in some embodiments, no metal salts of this type are used.

Particularly preferred reducing agents are dextrose, ascorbic acid (salts) or sodium formaldehyde sulfoxylate (Rongalit® C).

The graft polymer B.2 to be used according to the invention is produced by persulfate initiation.

Suitable persulfate compounds according to the invention include ammonium peroxodisulfate, potassium peroxodisulfate, sodium peroxodisulfate and/or mixtures thereof.

### Production of the Co-Precipitated Graft Polymers B.1 and B.2

The production of the graft polymers to be used according to the present invention can take place, for example, by mixing at least one graft polymer B.2 produced using at least one persulfate compound as initiator in latex form with at least one graft polymer B.1 produced using at least one redox system as initiator in latex form, homogeneous blending of the latices and working up of the resulting graft polymer mixed product using known processes.

Examples of suitable work-up processes include e.g. the precipitation of the graft polymer dispersion mixture by the action of aqueous electrolyte solutions, such as e.g. solutions of salts (e.g. magnesium sulfate, calcium chloride, sodium chloride), solutions of acids (e.g. sulfuric acid, phosphoric acid, acetic acid) or mixtures thereof, precipitation by the action of cold (freeze coagulation) or direct recovery of the co-precipitation product from the dispersion mixture (latex) by spray drying.

In the case of the precipitation of the graft polymer mixture, a washing step (preferably with water) and a drying step (e.g. in a fluidised bed dryer or a flash dryer) generally follow.

The pH of component B generally has a value of 3 to 9, preferably of 4 to 8 and particularly preferably of 5 to 7. To determine the pH of component B, it is slurried in freshly distilled water to form a 10% (wt. %) suspension.

The graft polymers B.1 and B.2 can be co-precipitated in any mix ratios. The weight ratio of B.1:B.2 is preferably 95:5 to 5:95, particularly preferably 90:10 to 25:75 and most particularly preferably 85:15 to 50:50.

In an alternative work-up process, the moist graft polymer mixture can be mixed with a thermoplastic resin melt (component C) in a kneader reactor after precipitation. Details of this work-up process are described, for example, in EP-A 867 463. The compositions of the graft polymer mixture and thermoplastic resin according to component C obtained by this work-up process can be used to produce the moulding compositions according to the invention. The co-precipitated graft polymer B is preferably present here in dispersed form in a matrix of vinyl (co)polymer C.1 (particularly styrene/acrylonitrile copolymer). The weight ratio of B:C.1 here=90:10 to 10:90, preferably 80:20 to 30:70 and particularly preferably 70:30 to 40:60.

In principle, it is also possible to mix together the polycarbonate or polyester carbonate component A, the graft polymer component obtained by co-precipitation of B.1 and B.2 and the vinyl (co)polymer component C.1 and/or polyalkylene terephthalate component C.2 and optional additives in a compounding step in conventional compounding equipment, and then to mix them with the other components and process them further in the conventional manner. In addition, it is also possible to mix components B and C separately with the other components and additives and to process them further.

### Component C

Component C typically comprises one or more thermoplastic vinyl (co)polymers C.1 and/or polyalkylene terephthalates C.2.

Suitable as vinyl (co)polymers C.1 include polymers of at least one monomer from the group of the vinyl aromatics, vinyl cyanides (unsaturated nitriles), (meth)acrylic acid (C₁-C₈) alkyl esters, unsaturated carboxylic acids and derivatives (such as anhydrides and imides) of unsaturated carboxylic acids. Particularly suitable include (co)polymers of
C.1.1 50 to 99, preferably 60 to 80 parts by weight vinyl aromatics and/or ring-substituted vinyl aromatics such as styrene, α-methylstyrene, p-methylstyrene, p-chlorostyrene) and/or (meth)acrylic acid (C₁-C₈) alkyl esters, such as methyl methacrylate, ethyl methacrylate), and
C.1.2 1 to 50, preferably 20 to 40 parts by weight vinyl cyanides (unsaturated nitriles) such as acrylonitrile and methacrylonitrile and/or (meth)acrylic acid (C₁-C₈) alkyl esters, such as methyl methacrylate, n-butyl acrylate, t-butyl acrylate, and/or unsaturated carboxylic acids, such as maleic acid, and/or derivatives, such as anhydrides and imides, of unsaturated carboxylic acids, e.g. maleic anhydride and N-phenylmaleimide).

The vinyl (co)polymers C.1 are resinous, thermoplastic and rubber-free. Particularly preferred is the copolymer of C.1.1 styrene and C.1.2 acrylonitrile.

The (co)polymers according to C.1 are known and can be produced, for example, by free-radical polymerisation, particularly by emulsion, suspension, solution or bulk polymerisation. The (co)polymers preferably possess average molecular weights Mw (weight average, determined by light scattering or sedimentation) of between 15,000 and 200,000.

The polyalkylene terephthalates of component C.2 can be reaction products of aromatic dicarboxylic acids or their reactive derivatives, such as dimethyl esters or anhydrides, and aliphatic, cycloaliphatic or araliphatic diols, as well as mixtures of these reaction products.

Preferred polyalkylene terephthalates preferably contain at least about 80 wt. %, more preferably at least 90 wt. %, based on the dicarboxylic acid component, of terephthalic acid groups and at least about 80 wt. %, preferably at least 90 mole %, based on the diol component, of ethylene glycol and/or 1,4-butanediol groups.

Preferred polyalkylene terephthalates can optionally contain, in addition to terephthalic acid esters, up to about 20 mole %, preferably up to 10 mole %, groups of other aromatic or cycloaliphatic dicarboxylic acids with 8 to 14 C atoms or aliphatic dicarboxylic acids with 4 to 12 C atoms, such as e.g. groups of phthalic acid, isophthalic acid, 2,6-naphthalenedicarboxylic acid, 4,4′-diphenyldicarboxylic acid, succinic acid, adipic acid, sebacic acid, azelaic acid, cyclohexanediacetic acid.

Preferred polyalkylene terephthalates can contain, in addition to ethylene glycol or 1,4-butanediol groups, up to 20 mole %, preferably up to 10 mole %, of other aliphatic diols with 3 to 12 C atoms or cycloaliphatic diols with 6 to 21 C atoms, e.g. groups of 1,3-propanediol, 2-ethyl-1,3-propanediol, neopentyl glycol, 1,5-pentanediol, 1,6-hexanediol, 1,4-cyclohexanedimethanol, 3-ethyl-2,4-pentanediol, 2-methyl-2,4-pentanediol, 2,2,4-trimethyl-1,3-pentanediol, 2-ethyl-1,3-hexanediol, 2,2-diethyl-1,3-propanediol, 2,5-hexanediol, 1,4-di-(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxy-propoxyphenyl)propane (DE-A 2 407 674, 2 407 776, 2 715 932).

Polyalkylene terephthalates can be branched by incorporating relatively small amounts of 3- or 4-hydric alcohols or 3- or 4-basic carboxylic acids, e.g. according to DE-A 1 900 270 and U.S. Pat. No. 3,692,744. Examples of preferred branching agents include trimesic acid, trimellitic acid, trimethylolethane and -propane, and pentaerythritol.

Particularly preferred are polyalkylene terephthalates which have been made only from terephthalic acid and its reactive derivatives (e.g. its dialkyl esters) and ethylene glycol and/or 1,4-butanediol, and mixtures of these polyalkylene terephthalates.

Mixtures of polyalkylene terephthalates contain 1 to 50 wt. %, preferably 1 to 30 wt. %, polyethylene terephthalate and 50 to 99 wt. %, preferably 70 to 99 wt. %, polybutylene terephthalate.

The polyalkylene terephthalates preferably used generally have an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates can be produced, for example, by any known method (cf. e.g. Kunststoff-Handbuch, volume VIII, pp. 695 ff., Carl-Hanser-Verlag, Munich 1973).

### Component D

Phosphorus-containing flame retardants (component D) within the meaning according to the invention are preferably selected from the groups of the mono- and oligomeric phosphoric and phosphonic acid esters, phosphonate amines and phosphazenes, it being possible also to use mixtures of several components selected from one or various of these groups as flame retardants. It is also possible to use other halogen-free phosphorus compounds not specially mentioned here, individually or in any combination with other halogen-free phosphorus compounds.

Preferred mono- and oligomeric phosphoric or phosphonic acid esters include phosphorus compounds of the general formula (IV)

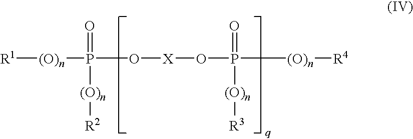

wherein

R¹, R², R³ and R⁴, independently of one another, each signify optionally halogenated C₁ to C₈ alkyl, optionally in each case substituted by alkyl, preferably C₁ to C₄ alkyl, and/or halogen, preferably chlorine or bromine, C₅ to C₆ cycloalkyl, C₆ to C₂₀ aryl or C₇ to C₁₂ aralkyl,

n independently of one another signifies 0 or 1,

q signifies 0 to 30 and

X signifies a mononuclear or polynuclear aromatic group with 6 to 30 C atoms, or a linear or branched aliphatic group with 2 to 30 C atoms, which can be OH-substituted and can contain up to 8 ether bonds.

R¹, R², R³ and R⁴, independently of one another, preferably denote C₁ to C₄ alkyl, phenyl, naphthyl or phenyl-C₁-C₄-alkyl. The aromatic groups R¹, R², R³ and R⁴ can, for their part, be substituted with halogen and/or alkyl groups, preferably chlorine, bromine and/or C₁-C₄ alkyl. Particularly preferred aryl groups are cresyl, phenyl, xylenyl, propylphenyl or butylphenyl and the corresponding brominated and chlorinated derivatives thereof.

X in formula (IV) preferably signifies a mononuclear or polynuclear aromatic group with 6 to 30 C atoms. This is preferably derived from diphenols of formula (I).

n in formula (IV) can, independently of one another, be 0 or 1; n preferably equals 1.

q denotes values of 0 to 30, preferably 0.3 to 20, particularly preferably 0.5 to 10, more particularly preferably 0.5 to 6, most particularly preferably 1.1 to 1.6.

X preferably denotes

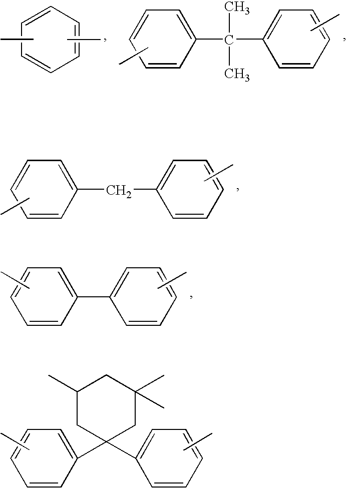

or the chlorinated or brominated derivatives thereof, X is particularly derived from resorcinol, hydroquinone, bisphenol A or diphenylphenol. X is particularly preferably derived from bisphenol A.

As component D according to the invention it is also possible to use mixtures of different phosphates.

Phosphorus compounds of formula (IV) are in particular tributyl phosphate, triphenyl phosphate, tricresyl phosphate, diphenylcresyl phosphate, diphenyloctyl phosphate, diphenyl-2-ethylcresyl phosphate, tri(isopropylphenyl) phosphate, resorcinol bridged oligophosphate and bisphenol A bridged oligophosphate. The use of oligomeric phosphoric acid esters of formula (IV), which are derived from bisphenol A, is particularly preferred.

Most preferred as component D is the bisphenol A-based phosphorus compound according to formula (IVa).

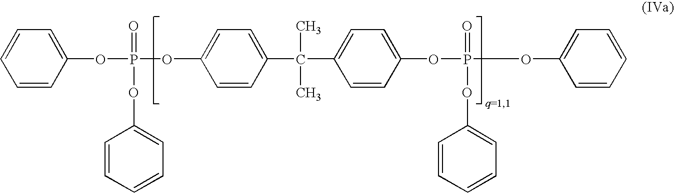

The phosphorus compounds according to component D are known (cf. e.g. EP-A 0 363 608, EP-A 0 640 655) or can be produced by known methods in a similar manner (e.g. Ullmanns Enzyklopädie der technischen Chemie, vol. 18, pp. 301 ff. 1979; Houben-Weyl, Methoden der organischen Chemie, vol. 12/1, p. 43; Beilstein vol. 6, p. 177).

If mixtures of various phosphorus compounds are used and in the case of oligomeric phosphorus compounds, the q value given is the average q value. The average q value can be determined by determining the composition of the phosphorus compound (molecular weight distribution) by a suitable method (gas chromatography (GC), high pressure liquid chromatography (HPLC), gel permeation chromatography (GPC)) and calculating the average values for q therefrom.

In addition, phosphonate amines and phosphazenes, as described in WO 00/00541 and WO 01/18105, can be used as flame retardants.

The flame retardants can be used individually or in any mixture with one another or in a mixture with other flame retardants.

### Component E

Suitable phenolic antioxidants can be at least one compound selected from the group consisting of sterically hindered phenols, hydroquinones and hydroquinone analogues, substituted compounds and antioxidants based on tocopherols and their derivatives.

The sterically hindered phenols can be mononuclear and/or polynuclear. Moreover, the sterically hindered phenols can be substituted and also bridged via substituents. These include both monomeric and oligomeric compounds, which can be made up of several phenolic parent substances.

As phenolic antioxidants, it is preferable to use one or more compounds selected from the group consisting of 2,6-di-tert.-butylphenol, 2,6-di-tert.-butylcresol (also known e.g as BHT, Tonol 330), tetrakis[methylene-(3,5-di-tert.-butyl-4-hydroxycinnamate)]methane (Irganox® 1010), 2,2′-methylene-bis(4-methyl-6-tert.-butylphenol) (Cyanox® 2246), benzenepropanoic acid-3,5-bis(1,1-dimethylethyl)-4-hydroxy-, 1,1′-(thiodi-2,1-ethanediyl) ester (Irganox® 1035), 1,1,3-tri(3-tert-butyl-4-hydroxy-6-methylphenyl)butane (Topanol® CA), octadecyl-3-(3,5-di-tert-butyl-4-hydroxyphenyl) propionate (Irganox® 1076), 4,4′-butylidene bis(6-tert.-butyl-3-methylphenol) (Santowhite® powder), 1,3,5-tris(2,6-dimethyl-4-tert-butyl-3-hydroxybenzyl) isocyanurate (Cyanox® 1790), 1,3,5-tris(3,5-di-tert-butyl-4-hydroxybenzyl)-s-triazine-2,4,6(1H,3H,5H)-trione (Goodrite® 3114), 1,3,5-tris[2-[3-(3,5-di-tert-butyl-4-hydroxyphenyl)-propionyloxy]ethyl]-s-triazine-2,4,6(1H,3H,5H)-trione (Goodrite® 3125), 1,3,5-tris(3,5-di-tert-butyl-4-hydroxyphenylmethyl)-2,4,6-trimethylbenzene (Ethanox® 330, Irganox® 1330), 4,4′-thiobis[2-tert-butyl-5-methylphenol] (Santonox® R), 2,2′-methylenebis(6-cyclohexyl-4-methylphenol) (Vulkanox® ZKF).

In a particularly preferred embodiment, octadecyl-3-(3,5-di-tert-butyl-4-hydroxyphenyl) propionate is used as component E.

### Component F:

The neutral phosphorus- or sulfur-containing co-stabilisers to be used according to the present invention can in particular be compounds which preferably contain neither basic nor acidic functional groups.

As neutral phosphorus- and sulfur-containing synergists it is often preferable to use one or more compounds selected from the group consisting of tris(nonylphenyl) phosphite (TNPP), tris(2,4-tert-butylphenyl) phosphite (Irgafos® 168), pentaerythritol bis-(stearylphosphite) (Weston® 618), pentaerythritol bis(2,6-di-tert.-butylphenol phosphite) (Ultranox® 626), tetrakis(2,4-di-tert-butylphenyl)[1,1′-biphenyl]-4,4′-diylbisphosphonite (Sandostab® P-EPQ, Irgafos P-EPQ), dialkyl thiodipropionates such as e.g. dilauryl thiodipropionate (DLTDP), distearyl thiodipropionate (DSTDP).

In a particularly preferred embodiment, Irgafos® 168 is used as component F.

According to this invention, it is unsuitable to include stabilisers (i.e. as component E) and synergists (i.e. as component F) which contain basic or acidic functional groups, e.g. dialkyl phosphites, diaryl phosphites (such as e.g. diphenyl phosphite according to formula (V) or 2,2′-methylenebis(6-cyclohexyl-4-methylphenyl) phosphite according to formula (VI)).

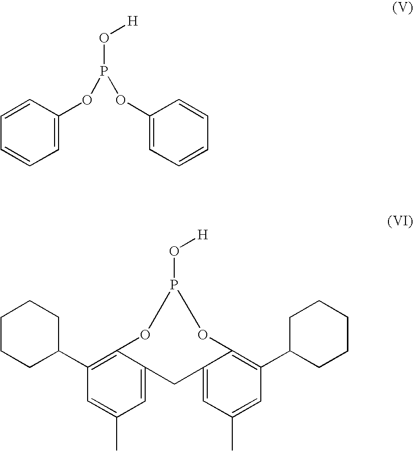

### Component G

The composition can contain other commercial additives according to component G, such as flame retardant synergists, rubber-modified graft polymers other than component B, anti-dripping agents (e.g. compounds of the classes of substances of the fluorinated polyolefins, such as e.g. polytetrafluoroethylene, the silicones and aramid fibres), lubricants and mould release agents (e.g. pentaerythritol tetrastearate), nucleating agents, antistatic agents (e.g. conductive carbon blacks, carbon fibres, carbon nanotubes and organic antistatic agents, such as polyalkylene ethers, alkyl sulfonates or polyamide-containing polymers), acids, fillers and reinforcing materials (e.g. glass or carbon fibres, mica, kaolin, talc, CaCO3 and glass flakes) as well as dyes and pigments.

The graft polymers other than component B are produced by free-radical polymerisation, e.g. by emulsion, suspension, solution or bulk polymerisation. Graft polymers other than component B produced by solution or bulk polymerisation are preferred.

Fluorinated polyolefins are known and described e.g. in EP-A 0 640 655. They are marketed for example by DuPont under the trade mark Teflon® 30N.

The fluorinated polyolefins can be used both in pure form and in the form of a coagulated mixture of emulsions of the fluorinated polyolefins with emulsions of the graft polymers according to component B or with an emulsion of a vinyl monomer based (co)polymer, particularly one based on styrene/acrylonitrile or methyl methacrylate, the fluorinated polyolefin being mixed as an emulsion with an emulsion of the graft polymer or of the copolymer and then coagulated.

Furthermore, the fluorinated polyolefins can be used as a pre-compound with the graft polymer component B or a copolymer, preferably vinyl monomer based. The fluorinated polyolefins are mixed as a powder with a powder or granules of the graft polymer or copolymer and melt-compounded, generally at temperatures of 200 to 330° C. in conventional equipment such as internal mixers, extruders or twin screw extruders.

The fluorinated polyolefins can also be used in the form of a masterbatch, which is produced by emulsion polymerisation of at least one monoethylenically unsaturated monomer in the presence of an aqueous dispersion of the fluorinated polyolefin. Preferred monomer components are styrene, acrylonitrile, methyl methacrylate and mixtures thereof. The polymer is used as a free-flowing powder after acidic precipitation and subsequent drying.

The coagulates, pre-compounds or masterbatches generally have solids contents of fluorinated polyolefin of 5 to 95 wt. %, preferably 7 to 80 wt. %.

The fluorinated polyolefins are preferably used in concentrations of 0 to 2 wt. %, particularly of 0.1 to 0.5 wt. %, based on the sum of the parts by weight of components A+B+C, these quantitative data relating to the pure fluorinated polyolefin when a coagulate, pre-compound or masterbatch is used.

### Production of the Moulding Compositions and Mouldings

The compositions according to the invention are produced by mixing the respective constituents in a known manner and melt-compounding and melt-extruding them at temperatures of 200° C. to 300° C. in conventional equipment such as internal mixers, extruders and twin screw extruders.

The mixing of the individual constituents can take place in a known manner both successively and simultaneously, and both at about 20° C. (room temperature) and at a higher temperature.

The moulding compositions according to the invention can be used for the production of moulded parts of any type. These can be produced by injection moulding, extrusion and blow moulding processes. Another form of processing is the production of mouldings by thermoforming from previously produced sheets or films and the in-mould decoration (IMD) process.

Examples of such moulded parts are films, profiles, housing parts of any type, e.g. for domestic appliances such as juice presses, coffee machines, mixers; for office equipment such as monitors, printers, copiers; interior and exterior parts for cars, panels, pipes, electrical installation channels, windows, doors and other profiles for the building sector (interior fittings and exterior applications) as well as electrical and electronic parts such as switches, plugs and sockets.

In particular, the moulding compositions according to the invention can also be used for example for the production of the following moulded parts: interior fittings for rail vehicles, ships, aircraft, buses and other motor vehicles, external body parts in the automotive sector, housings of electrical equipment containing small transformers, housings for equipment for information processing and transfer, housings and claddings for medical equipment, massage equipment and housings therefor, toy vehicles for children, flat wall elements, housings for safety devices, thermally insulated transport containers, apparatus for keeping or caring for small animals, moulded parts for sanitary and bath fittings, cover grids for ventilation openings, moulded parts for summer houses and sheds and housings for garden equipment.

The invention therefore also provides a process for the production of the compositions and their use for the production of moulded parts and the moulded parts themselves.

### EXAMPLES

### Component A

Linear polycarbonate based on bisphenol A with a weight average molecular weight M̅_{w} of 27500 g/mol (determined by GPC in CH₂Cl₂ at 25° C.).

### Component B

All statements of parts by weight in the following examples relating to graft polymers are standardised such that, in each graft polymer given below, the sum of the parts by weight of the backbone (polybutadiene) and the parts by weight of the graft monomers (styrene and acrylonitrile) adds up to 100 parts by weight. The quantities of water, emulsifiers, initiators and other auxiliary agents are based on this sum of the parts by weight of the backbone and the graft monomers (=100 parts by weight).

### Production of the Rubber Backbone B2.3:

In a first step, the polybutadiene latices B2.1 and B2.2 are each produced separately by free-radical emulsion polymerisation of butadiene in the presence of the sodium salt of a TCD emulsifier as described in EP-A 394 779 (example 1) (cf. simplified formula (VII)).

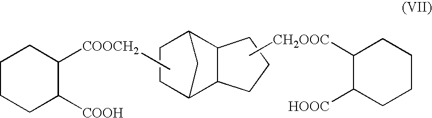

The production of the polybutadiene latices B2.1 and B2.2 is carried out by methods known to the person skilled in the art such that they each have a certain mean weight-average particle size d₅₀:

B2.1: d₅₀=290 nm

B2.2: d₅₀=400 nm

The solids content of the latices B2.1 and B2.2 is 45 wt. % in each case.

In a second step these polybutadiene latices B2.1 and B2.2 are mixed together in a weight ratio of 1:1 (based on solid polymer). The resulting polybutadiene rubber backbone B2.3 has a bimodal particle size distribution with a mean weight-average particle size d₅₀=345 nm. The solids content of the polybutadiene rubber backbone B2.3 is 45 wt. %.

### General Specification (I) (Redox Initiation):

### Production of Graft Polymers of the Type B-I

60 parts by weight B2.3 (calculated as solids) are diluted with water to a solids content of 20 wt. %. The mixture is then heated to 60° C. and 0.3 parts by weight tert.-butyl hydroperoxide (dissolved in 20 parts by weight water) and 0.4 parts by weight sodium ascorbate (dissolved in 20 parts by weight water) are metered in simultaneously within 8 h.

Within 4 h the following components are then metered in simultaneously, at the same time also increasing the reaction temperature stepwise to 80° C. within these 4 h:
a) 40 parts by weight of a monomer mixture (weight ratio styrene:acrylonitrile=73:27)), and
b) 1.5 or 2.2 parts by weight (calculated as solid substance; the quantity used in each case can be taken from the following components and tables) of the sodium salt of a disproportionated resin acid (Dresinate® 731), Abieta Chemie GmbH, Gersthofen), dissolved in water adjusted with NaOH to be alkaline (pH=10-12).

The reaction mixture is left at 80° C. for 2 h (post-reaction period). Afterwards, 1 part by weight of a phenolic antioxidant is added and mixed.

The resulting graft polymer dispersion with a solids content of 32 wt. % is then worked up (cf. the corresponding general specification below).

### General Specification (II) (Persulfate Initiation):

### Production of Graft Polymers of the Type B-II

60 parts by weight B2.3 (calculated as solids) are diluted with water to a solids content of 20 wt. %. The mixture is then heated to 60° C. and 0.5 parts by weight potassium peroxodisulfate (dissolved in 25 parts by weight water) are added.

Within 6 h the following components are then metered in simultaneously, at the same time also increasing the reaction temperature stepwise to 80° C. within these 6 h:

a) 40 parts by weight of a monomer mixture (weight ratio styrene:acrylonitrile=73:27)),

b) 0.1 parts by weight tert-dodecyl mercaptan and

c) 1.0 or 1.4 parts by weight (calculated as solid substance; the quantity used in each case can be taken from the following components and tables) of the sodium salt of a disproportionated resin acid (Dresinate® 731, Abieta Chemie GmbH, Gersthofen), dissolved in water adjusted with NaOH to be alkaline (pH=10-12).

The reaction mixture is left at 80° C. for 2 h (post-reaction period). Afterwards, 1 part by weight of a phenolic antioxidant is added and mixed.

The resulting graft polymer dispersion of 32 wt. % is then worked up (cf. the corresponding general specification below).

### General Specification for Working Up a Graft Polymer Dispersion Produced According to the General Specification (I) or (II):

In the following examples, it is specified whether the graft polymer dispersions produced according to the general specification (I) or (II) are worked up separately or as a co-precipitation.

a) Separate Precipitation:

Each graft polymer dispersion is added to a precipitation solution (consisting of 2 parts by weight magnesium sulfate, 1 part by weight acetic acid and 100 parts by weight water) at 95° C., filtered off and the resulting powder is dried at 70° C. in vacuo until a residual moisture content of <0.5 wt. % is reached. The pH of the powder slurried in freshly distilled water to form a 10% (wt. %) suspension has a value of between 6 and 7.

b) Co-Precipitation:

75 parts by weight (based on solids) of the graft polymer dispersion B-I and 25 parts by weight (based on solids) of the graft polymer dispersion B-II are mixed together and then added to a precipitation solution (consisting of 2 parts by weight magnesium sulfate, 1 part by weight acetic acid and 100 parts by weight water) at 95° C., filtered off and the resulting powder is dried at 70° C. in vacuo until a residual moisture content of <0.5 wt. % is reached. The pH of the powder slurried in freshly distilled water to form a 10% (wt. %) suspension has a value of between 6 and 7.

### Component B1(1)

ABS emulsion graft polymer produced according to general specification (1) using 1.5 parts Dresinate® 731, and worked up by means of separate precipitation.

### Component B1(2)

ABS emulsion graft polymer produced according to general specification (I) using 2.2 parts Dresinate® 731, and worked up by means of separate precipitation.

### Component B2(1)

ABS emulsion graft polymer produced according to general specification (II) using 1.0 part Dresinate® 731, and worked up by means of separate precipitation.

### Component B2(2)

ABS emulsion graft polymer produced according to general specification (II) using 1.4 parts Dresinate® 731, and worked up by means of separate precipitation.

### Component B(1)

ABS emulsion graft polymer produced by working up by co-precipitation of 75 parts by weight (based on solids) of the graft polymer dispersion B-I produced according to general specification (I) using 1.5 parts Dresinate® 731 and

25 parts by weight (based on solids) of the graft polymer dispersion B-II produced according to general specification (II) using 1.0 part Dresinate® 731.

### Component B(2)

ABS emulsion graft polymer produced by working up by co-precipitation of 5 parts by weight (based on solids) of the graft polymer dispersion B-I produced according to general specification (I) using 2.2 parts Dresinate® 731 and

25 parts by weight (based on solids) of the graft polymer dispersion B-II produced according to general specification (II) using 1.4 parts Dresinate® 731.

### Component C

C-1: Copolymer of 75 wt. % styrene and 25 wt. % acrylonitrile with a weight average molecular weight M_{w} of 130 kg/mol (determined by GPC), produced by the bulk polymerisation process.

C-2: Copolymer of 72 wt. % styrene and 28 wt. % acrylonitrile with a weight average molecular weight M_{w} of 100 kg/mol (determined by GPC), produced by the bulk polymerisation process.

### Component D

D-1: Bisphenol A diphenyl diphosphate, Reofos BAPP, Great Lakes

D-2: Triphenyl phosphate, Disflamoll TP, Lanxess

### Component E

E-1: Octadecyl-3-(3,5-di-tert-butyl-4-hydroxyphenyl) propionate (a sterically hindered phenol, Irganox® 1076, Ciba Spezialitatenchemie)

E-2: 2,2′-Methylenebis(6-cyclohexyl-4-methylphenyl) phosphite (as acidic phosphite stabiliser) (comparison)

### Component F

F-1: Tris(2,4-di-tert-butylphenyl) phosphite (Irgafos® 168, Ciba Spezialitätenchemie)

F-2: DLTDP (dilauryl thiodipropionate) (ABCR)

### Component G

G-1: Pentaerythritol tetrastearate

G-2: Poly(tetrafluoroethylene) (PTFE, CFP 6000N, DuPont)

### Production and Testing of the Moulding Compositions

The mixing of the components used with the conventional processing auxiliaries took place either in a ZSK 25 twin screw extruder or in a 1.3 litre internal mixer. The mouldings are produced on an injection moulding machine, Arburg 270E model, at 240° C., 260° C. or at 300° C.

The compositions of the moulding compositions produced can be taken from tables 1 to 4 below.

The evaluation of the inherent colour/natural colour took place by determining the yellowness index (YI) of colour sample sheets measuring 60×40×2 mm according to ASTM standard E-313-96 (illuminant: C, observer: 2°, measuring aperture: large area value) according to the equation YI=(128X-106Z)/Y, with X, Y, Z=colour coordinates according to DIN 5033. Depending on the temperature at which the mouldings were produced in the injection moulding machine, this is stated in the table as YI/260° C. or YI/300° C.

As a measure of the hydrolysis resistance of the compositions thus produced, the change in MVR is used, measured in accordance with ISO 1133 at 260° C. (in the case of flame retardant-free compositions) or at 240° C. (in the case of compositions containing flame retardants) with a 5 kg load for a 7-day storage period of the granules at 95° C. and 100% relative humidity (“FWL storage”) for polycarbonate compositions without flame retardant and a 2-day storage period of the granules at 95° C. and 100% relative humidity (“FWL storage”) for polycarbonate compositions which contain flame retardants. The increase in MVR value compared with the MVR value before the corresponding storage is calculated as ΔMVR(hydr.), which is defined by the following formula.

$$Δ MVR ( hyrdr ) = \frac{\begin{matrix}MVR ( after FWL - storage ) - \\ MVR ( before storage )\end{matrix}}{MVR ( before storage )} \cdot 100 \%$$

The characterisation of the flame retardant properties takes place in accordance with UL 94 V (on bars measuring 127×12.7×1.5 mm).

TABLE 1
Properties of the compositions without flame retardant
1st Series. Production of the moulding compositions in a ZSK25 twin screw extruder

| | | | | 3 | 4 | 5 | 6 | 7 | 8 | 9 | 10 | 11 | 12 |
|---|---|---|---|---|---|---|---|---|---|---|---|---|---|
| | | 1 | 2 | (Cp.) | (Cp.) | (Cp.) | (Cp.) | (Cp.) | (Cp.) | (Cp.) | (Cp.) | (Cp.) | (Cp.) |
| Composition | | | | | | | | | | | | | |
| A | Pts. by wt. | 58 | 58 | 58 | 58 | 58 | 58 | 58 | 58 | 58 | 58 | 58 | 58 |
| B (1) | Pts. by wt. | 18 | | | | | | | | | 18 | | |
| B (2) | Pts. by wt. | | 18 | | | | | | | | | 18 | |
| B1 (1) | Pts. by wt. | | | 18 | | 13.5 | | | 18 | | | | 13.5 |
| B1 (2) | Pts. by wt. | | | | | | 18 | | | | | | |
| B2 (1) | Pts. by wt. | | | | 18 | 4.5 | | | | 18 | | | |
| B2 (2) | Pts. by wt. | | | | | | | 18 | | | | | 4.5 |
| C-1 | Pts. by wt. | 24 | 24 | 24 | 24 | 24 | 24 | 24 | 24 | 24 | 24 | 24 | 24 |
| E-1 | Pts. by wt. | 0.13 | 0.13 | 0.13 | 0.13 | 0.13 | 0.13 | 0.13 | | | | | |
| E-2 | Pts. by wt. | | | | | | | | 0.12 | 0.12 | 0.12 | 0.12 | 0.12 |
| F-1 | Pts. by wt. | 0.09 | 0.09 | 0.09 | 0.09 | 0.09 | 0.09 | 0.09 | | | | | |
| G-1 | Pts. by wt. | 0.75 | 0.75 | 0.75 | 0.75 | 0.75 | 0.75 | 0.75 | 0.75 | 0.75 | 0.75 | 0.75 | 0.75 |
| Properties | | | | | | | | | | | | | |
| ΔMVR (hydr.) | [%] | 105 | 112 | 100 | 95 | 92 | 140 | 82 | 282 | 167 | 191 | 228 | 274 |
| YI/260° C. | | 19 | 19 | 28 | 37 | 29 | 32 | 30 | 42 | 40 | 33 | 29 | 38 |
| YI/300° C. | | 25 | 25 | 30 | 37 | 29 | 36 | 34 | 45 | 43 | 38 | 32 | 41 |

TABLE 2
Properties of the compositions without flame retardant
2^{nd} Series -
Production of the moulding compositions in a 1.3-litre internal mixer

| | | | | | | 17 |
|---|---|---|---|---|---|---|
| | | 13 | 14 | 15 | 16 | (Cp.) |
| Composition | | | | | | |
| A | Pts. by wt. | 58 | 58 | 58 | 58 | 58 |
| B (2) | Pts. by wt. | 18 | 18 | 18 | 18 | 18 |
| C-1 | Pts. by wt. | 24 | 24 | 24 | 24 | 24 |
| E-1 | Pts. by wt. | 0.13 | 0.13 | 0.13 | 0.13 | 0.13 |
| E-2 | Pts. by wt. | | | | | 0.12 |
| F-1 | Pts. by wt. | | 0.09 | | 0.09 | |
| F-2 | Pts. by wt. | | | 0.09 | 0.09 | |
| G-1 | Pts. by wt. | 0.75 | 0.75 | 0.75 | 0.75 | 0.75 |
| Properties | | | | | | |
| ΔMVR | [%] | 109 | 121 | 126 | 128 | 212 |
| (hydr.) | | | | | | |
| YI/260° C. | | 29 | 28 | 31 | 31 | 36 |
| YI/300° C. | | 34 | 32 | 32 | 33 | 42 |

TABLE 3
Properties of the compositions with flame retardant
Production of the moulding compositions in a ZSK25 twin screw extruder

| | | | 19 |
|---|---|---|---|
| Composition | | 18 | (Cp.) |
| A | Pts. by wt. | 80.3 | 80.3 |
| B(2) | Pts. by wt. | 12.5 | 12.5 |
| C-1 | Pts. by wt. | 7.2 | 7.2 |
| D-1 | Pts. by wt. | 12.8 | 12.8 |
| D-2 | Pts. by wt. | 4.2 | 4.2 |
| E-1 | Pts. by wt. | 0.02 | |
| E-2 | Pts. by wt. | | 0.12 |
| F-1 | Pts. by wt. | 0.09 | |
| G-1 | Pts. by wt. | 0.5 | 0.5 |
| G-2 | Pts. by wt. | 0.5 | 0.5 |
| Properties | | | |
| ΔMVR(hydr.) | [%] | 150 | 350 |
| YI/260° C. | | 14 | 22 |
| YI/300° C. | | 26 | 29 |

TABLE 4
Properties of the compositions with flame retardant
Production of the moulding compositions in a ZSK25 twin screw extruder

| | | | | | 23 |
|---|---|---|---|---|---|
| | | 20 | 21 | 22 | (Cp.) |
| Composition | | | | | |
| A | Pts. by wt. | 79.0 | 79.0 | 79.0 | 79.0 |
| B (2) | Pts. by wt. | 13.4 | 13.4 | 13.4 | 13.4 |
| C-1 | Pts. by wt. | 7.6 | 7.6 | 7.6 | 7.6 |
| D-1 | Pts. by wt. | 17.1 | 17.1 | 17.1 | 17.1 |
| E-1 | Pts. by wt. | 0.02 | 0.02 | 0.02 | |
| E-2 | Pts. by wt. | | | | 0.12 |
| F-1 | Pts. by wt. | | 0.09 | | |
| F-2 | Pts. by wt. | | | 0.12 | |
| G-1 | Pts. by wt. | 0.5 | | | 0.5 |
| G-2 | Pts. by wt. | 0.5 | | | 0.5 |
| Properties | | | | | |
| ΔMVR (hydr.) | [%] | 167 | 155 | 153 | 462 |
| YI/260° C. | | 45 | 39 | 41 | 49 |
| YI/300° C. | | 44 | 42 | 43 | 49 |
| UL94V/1.5 mm | Evaluation | V-0 | V-0 | V-0 | V-0 |
| Post burn time | [sec] | 10 | 11 | 11 | 13 |

It is clear from the examples listed above that the impact-modified polycarbonate moulding compositions which contain an emulsion graft polymer (ABS) according to the invention as impact modifier have a good natural colour and good hydrolysis resistance if they are stabilised with a phenolic antioxidant (E-1) with optionally added synergists such as neutral organic phosphites (F-1) or thio compounds (F-2). The emulsion graft polymer (ABS) according to the invention comprises, consists essentially of, or consists of two components, one of which is polymerised by means of redox initiation and the other by means of inorganic persulfate initiation, both components having been mixed together as latices at the stage of the graft polymer dispersion and co-precipitated as a latex mixture.

In detail, the compositions 1 and 2 according to the invention display both good hydrolysis resistance (ΔMVR(hydr.)=105% or 112%) and a very light natural colour (YI of 19 after injection moulding at 260° C. melt temperature and 80° C. mould temperature or YI of 25 after injection moulding at 300° C. melt temperature and 80° C. mould temperature). On the other hand, the compositions of comparative examples 3, 4, 6 and 7, which contain as emulsion ABS one of the individual components (i.e. B1(1), B1(2) or B2(2)), and the composition of comparative example 5 (contains a mixture of B1(1) and B2(1), these components having been mixed together as powders and not at the stage of the graft polymer dispersions, in contrast to the present invention), exhibit a good hydrolysis resistance but exhibit, however, a significantly poorer natural colour (YI>28 in each case; even after injection moulding at 260° C. melt temperature and 80° C. mould temperature).

These results discussed above are also reflected in the second test series (table 2), although because of the more severe processing conditions a poorer overall level of natural colour results, which can be explained by the longer residence time of the composition in an internal mixer than in an extruder. Thus, the results shown in table 2 also prove that the compositions according to the invention are distinguished by a good natural colour and at the same time high hydrolytic stability.

All compositions (comparative examples) containing an acidic phosphite stabiliser E-2 display both poorer hydrolysis resistance and a significantly poorer natural colour than the compositions according to the present invention, which, in contrast, contain a neutral phenolic antioxidant E-1 and optionally as synergist a neutral organic phosphite F-1 or a thio compound F-2 (cf. tables 3 and 4).

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” can connote the singular or plural.

In the present description and in the following claims, to the extent a numerical value is enumerated, such value is intended to refer to the exact value and values close to that value that would amount to an insubstantial change from the listed value.

1. A composition comprising:
A) an aromatic polycarbonate and/or aromatic polyester carbonate,
B) a graft polymer obtainable by co-precipitation of a mixture of at least two graft polymer dispersions B.1 and B.2, wherein production of the graft polymer component B.1 takes place using at least one redox system as an initiator and further wherein the production of the graft polymer component B.2 takes place using at least one persulfate compound as an initiator, and
E) at least one phenolic antioxidant.

2. A composition according to claim 1 comprising:
A) 10 to 99 parts by weight of said aromatic polycarbonate and/or aromatic polyester carbonate,
B) 1 to 50 parts by weight of said graft polymer,
C) 0 to 40 parts by weight of a vinyl (co)polymer and/or polyalkylene terephthalate,
D) 0 to 50 parts by weight, based on the sum of components A+B+C, of a phosphorus-containing flame retardant,
E) 0.005 to 1 parts by weight, based on the sum of components A+B+C, of said at least one phenolic antioxidant,
F) 0 to 4 parts by weight, based on the sum of components A+B+C, of a neutral phosphorus- and/or sulfur-containing co-stabiliser, and
G) 0 to 50 parts by weight, based on the sum of components A+B+C, of an additive.

3. A composition according to claim 2 comprising 0.01 to 2 parts by weight, based on the sum of components A+B+C, of said component F.

4. A composition according to claim 2 comprising 0.02 to 0.3 parts by weight of said component E and 0.05 to 0.5 parts by weight of said component F, based in each case on the sum of the parts by weight of components A+B+C.

5. A composition according to claim 1, wherein the component B is a graft polymer produced by co-precipitation of a mixture of two graft polymer dispersions B.1 and B.2, wherein B.1 and B.2 are each a polymer dispersion in water of
i) 15 to 60 wt. % of at least one vinyl monomer on
ii) 85 to 40 wt. % of at least one backbone with glass transition temperatures of <10° C.

6. A composition according to claim 1, wherein the pH of component B is from 3 to 9.

7. A composition according to claim 5, wherein the backbone of component B has an average particle size, d₅₀ value, of 0.2 to 0.4 μm.

8. A composition according to claim 2, comprising 2 to 30 parts by weight, based on the sum of the parts by weight of components A+B+C, of said phosphorus-containing flame retardant component D.

9. A composition according to claim 8, comprising as said component D at least one mono- and/or oligomeric phosphorus compound of formula (IV) 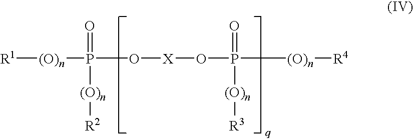
wherein
R¹, R², R³ and R⁴, independently of one another, each signify optionally halogenated C₁ to C₈ alkyl, optionally in each case alkyl- and/or halogen-substituted C₅ to C₆ cycloalkyl, C₆ to C₂₀ aryl or C₇ to C₁₂ aralkyl,
n independently of one another signifies 0 or 1,
q signifies 0 to 30 and
X signifies a mononuclear or polynuclear aromatic group with 6 to 30 C atoms, or a linear or branched aliphatic group with 2 to 30 C atoms, which can be OH-substituted and can contain up to 8 ether bonds.

10. A composition according to claim 1, wherein component E is at least one compound selected from the group consisting of
2,6-di-tert.-butylphenol, 2,6-di-tert.-butylcresol,
tetrakis[methylene-(3,5-di-tert.-butyl-4-hydroxycinnamate)]methane,
2,2′-methylenebis(4-methyl-6-tert.-butylphenol), benzenepropanoic acid-3,5-bis(1,1-dimethylethyl)-4-hydroxy-, 1,1′-(thiodi-2,1-ethandiyl) ester,
1,1,3-tri(3-tert-butyl-4-hydroxy-6-methylphenyl)butane,
octadecyl-3-(3,5-di-tert-butyl-4-hydroxyphenyl) propionate,
4,4′-butylidenebis(6-tert.-butyl-3-methylphenol),
1,3,5-tris(2,6-dimethyl-4-tert-butyl-3-hydroxybenzyl) isocyanurate,
1,3,5-tris(3,5-di-tert-butyl-4-hydroxybenzyl)-s-triazine-2,4,6(1H,3H,5H)-trione,
1,3,5-tris[2-[3-(3,5-di-tert-butyl-4-hydroxyphenyl)propionyloxy]ethyl]-s-triazine-2,4,6(1H,3H,5H)-trione,
1,3,5-tris(3,5-di-tert-butyl-4-hydroxyphenylmethyl)-2,4,6-trimethylbenzene,
4,4′-thiobis[2-tert-butyl-5-methylphenol], and
2,2′-methylenbis(6-cyclohexyl-4-methylphenol).

11. A composition according to claim 2, comprising 0.01 to 2 parts by weight, based in each case on the sum of the parts by weight of components A+B+C, of neutral phosphorus- and/or sulfur-containing co-stabilisers, which contain neither basic nor acidic functional groups, as said component F.

12. A composition according to claim 11, wherein component F is at least one compound selected from the group consisting of
tris(nonylphenyl) phosphite,
tris(2,4-tert-butylphenyl) phosphite,
pentaerythritol bis(stearyl phosphite),
pentaerythritol bis(2,6-di-tert.-butylphenol phosphite),
tetrakis(2,4-di-tert.-butylphenyl) [1,1′-biphenyl]-4,4′-diylbisphosphonite,
dilauryl thiodipropionate, and
distearyl thiodipropionate.

13. A method for the production of a moulding comprising employing a composition of claim 1.

14. A moulding comprising a composition according to claim 1.

15. A moulding according to claim 14, wherein the moulding is a part of a motor vehicle, rail vehicle, aircraft, watercraft, a film, a profile and/or a housing part.
